(19) United States
(12) Patent Application Publication
(10) Pub. No.: US 2018/0269757 A1
(43) Pub. Date: Sep. 20, 2018

(54) METHOD FOR WINDING A WIRE ABOUT A TOOTHED PART OF AN ELECTRIC MOTOR

(71) Applicant: Brose Fahrzeugteile GmbH & Co. Kommanditgesellschaft, Wuerzburg, Wuerzburg (DE)

(72) Inventors: Daniel FIEDERLING, Wertheim (DE); Ralph KALTHOFF, Kuernach (DE); Wolfgang STRAUSS, Unterpleichfeld (DE)

(73) Assignee: Brose Fahrzeugteile GmbH & Co. Kommanditgesellschaft, Wuerzburg, Wuerzburg (DE)

(21) Appl. No.: 15/987,302

(22) Filed: May 23, 2018

Related U.S. Application Data
(63) Continuation of application No. PCT/EP2016/078340, filed on Nov. 21, 2016.

(30) Foreign Application Priority Data
Nov. 23, 2015 (DE) 10 2015 223 109.7

(51) Int. Cl. H02K 15/06; H02K 3/12; H02K 3/48

(52) U.S. Cl. CPC H02K 15/065; H02K 3/48; H02K 3/12

(57) ABSTRACT

A method and an apparatus for providing a toothed motor part of an electric motor with a winding using a coil wire with a round wire cross-section, wherein the coil wire is converted into a coil wire with a wire cross-section different from the round wire cross-section in a forming process, and the formed coil wire is wound around the teeth of the motor part to produce a rotating field winding.

This nonprovisional application is a continuation of International Application No. PCT/EP2016/078340, which was filed on Nov. 21, 2016, and which claims priority to German Patent Application No. 10 2015 223 109.7, which was filed in Germany on Nov. 23, 2015, and which are both herein incorporated by reference.

### BACKGROUND OF THE INVENTION

### Field of the Invention

The present invention relates to a method for providing a toothed motor part of an electric motor with a winding using a coil wire with a round wire cross-section. The invention additionally relates to an apparatus for carrying out the method, and a stator for an electric motor wound using such a method.

### Description of the Background Art

A brushless electric motor as a three-phase electric machine usually has a stator core on the stator side. The stator core has a number of star-shaped stator teeth, facing radially inward or outward, for example, which carry an electric rotating field winding in the form of individual stator coils, which in turn are wound from an insulated wire, which is to say a wire (copper wire) provided with an insulating layer, for example in the form of an insulating varnish. The coil ends of the coils are associated with individual branches or phases and are connected to one another in a predetermined manner through contact elements.

In the case of a brushless electric motor as a three-phase machine, the stator has three phases, and thus has at least three phase conductors or coil wires as phase windings, each of which is supplied with phase-shifted electric current in order to create a rotating magnetic field in which rotates a rotor or armature that normally is provided with permanent magnets. The wire ends of the coil wires are routed to a motor electronics unit to drive the electric motor. The coils of the rotating field winding are connected to one another in a specific manner by means of the wire ends. The type of connection is determined by the winding diagram of the rotating field winding, wherein a star connection or a delta connection of the coil wires as the winding diagram is customary.

The rotating field winding is applied to the stator teeth of the stator core, for example fully automatically by means of a single-needle winding method, or preferably by means of a multi-needle winding method. One measure for the packing density of the coil wire on the stator tooth or for the number of coil windings in an available winding space is the so-called fill factor.

The coil wires customarily have a circular (wire) cross-section, wherein, on account of geometry, the problem arises that only a comparatively low fill factor of the coil winding is possible. In other words, the round coil wires cannot be wound densely and compactly, with the result that unusable gaps are formed between adjacent coil windings.

From DE 20 2012 104 118 U1, a drawn metal wire with an insulating layer is known that has a polygonal wire cross-section. Due to the, e.g., rectangular or hexagonal (coil) wire, a more compact coil winding with essentially infinitesimal gaps is possible. The fill factor that is increased by this means has an advantageous effect on the strength of the rotating field that can be generated, since it is possible to accommodate a larger number of coil windings in the same installation space or winding space. Additional possibilities with regard to a miniaturization and/or material saving are made possible as a result.

It is disadvantageous that rectangular or polygonal coil wires are relatively cost-intensive as compared to coil wires with a round cross-section, which carries over adversely to the costs for manufacturing and winding the stator. Moreover, such shaped wires can be applied to only a limited extent, if at all, to the stator by means of a single-needle or multi-needle winding method. Coil winding methods or single segment winding methods, in particular, are suitable for this purpose.

### SUMMARY OF THE INVENTION

It is therefore an object of the present invention to provide a method for winding a toothed motor part that is especially economical. The invention has the additional object of specifying a suitable apparatus for carrying out the method. In addition, the invention has the object of specifying a stator for an electric motor wound using such a method.

In the method according to an exemplary embodiment of the invention, a toothed motor part of an electric motor is provided with a winding using a coil wire with a round wire cross-section. The toothed motor part is, for example, a rotor or a stator of the electric motor that is designed, for example, as an internal rotor motor or as an external rotor motor. The teeth of the motor part in this case can be implemented as individual toothed segments, for example.

The coil wire is converted into a coil wire with a wire cross-section different from a round wire cross-section in a forming process. In other words, the coil wire is plastically deformed under the application of one or more external forces such that its wire cross-section is brought from a round cross-sectional shape into a shape that differs therefrom.

In the forming process, all that is changed, in particular, is the cross-sectional shape, which is to say the geometric shape of the perimeter of the wire cross-section. The wire's cross-sectional area enclosed by the perimeter is substantially identical before and after the forming process, however, so that no change in electrical resistance occurs. The formed coil wire is then wound around the teeth of the motor part to produce a rotating field winding. This means that the winding process for producing the rotating field winding preferably follows the forming process without interruption, which is to say, in particular, without first cutting the coil wire to length.

It is thus possible, through the forming process, to adapt an economical round coil wire (round wire) to a winding geometry of the rotating field winding that is desirable in each case. In particular, the round wire can be formed into an essentially arbitrary shape. In this process it is possible, for example, to form the round wire into a rectangular coil wire (flat wire) to improve the fill factor and then to directly use it for winding the toothed motor part. In other words, an especially dense and compact rotating field winding with an especially high fill factor while simultaneously having low manufacturing costs is made possible. The increase in the fill factor ensures a higher power density of the rotating field winding, which, furthermore, carries over advantageously to a saving of material, weight, installation space, and/or winding space. The improved fill factor, in turn, gives rise to improved heat dissipation from the winding, thus improving the cooling of the rotating field winding in operation.

The coil wire can be a round, insulated wire, in particular made of a copper material. As a result, the coil wire is especially economical, on the one hand. On the other hand, the generally easily deformable copper material ensures that a forming process is possible that is mechanically especially simple. The manufacturing costs are reduced further as a result.

It is expedient here for the insulation surrounding the wire to be sufficiently elastic so that the insulation still encloses or jackets the formed rectangular wire cross-section essentially completely without being damaged during the forming process. In this way, the risk of winding shorts within the rotating field winding is avoided.

Advantageously, the stator is made of a star core and a yoke core. The star core has a number of teeth, which are implemented, in particular, as toothed segments. The teeth are first wound individually and are then assembled into a star core, which is pressed into the hollow, cylindrical yoke core to form the stator. In other words, the teeth preferably project outward during the winding process, which means that the star core is wound from the outside. As a result, the rotating field winding can be manufactured especially easily and economically in terms of winding technique.

In a suitable improvement of the method, provision is made that the shape of the wire cross-section of the formed coil wire is varied during the course of producing the rotating field winding. A variation of the shape of the formed wire cross-section should be understood here to mean, for example, a change in the height-to-width ratio. In other words, the preferably rectangular or polygonal wire cross-section of the formed coil wire within the rotating field winding transitions integrally or monolithically into a different cross-sectional shape that likewise is rectangular or polygonal. In particular, it is possible by this means that the wire cross-sections of two consecutive coil windings are implemented differently from one another in the course of one coil winding of the rotating field winding. As a result, an available winding space on the tooth in question can be filled essentially completely, by which means an especially high fill factor is possible.

In an embodiment, one or more angles of inclination between the lateral faces of the wire cross-section of the formed coil wire are varied during the course of producing the rotating field winding. In other words, an e.g., quadrilateral shape of the wire cross-section is formed from a rectangle into a parallelogram or into a trapezoid, for example. This means that the coil wire has various rounded (elliptical, oval) and/or polygonal (triangular, quadrilateral, hexagonal) cross-sectional shapes over the course of the rotating field winding. As a result, an especially optimal utilization of the available winding space is made possible, so that a high fill factor is ensured.

In an embodiment, it is conceivable, for example, that the coil wire is wound on the teeth of the motor part as an effective, integral combination of round wire, flat wire, and shaped wire—in accordance with the applicable wire cross-section. In particular, it is possible to form the coil wire in sections and individually to a variable cross-sectional shape so that the coil wire always has an optimum wire cross-section over the course of the rotating field winding. In other words, variations in the coil wire to an always-optimal cross-sectional shape of the wire are possible in the rotating field winding of a tooth. This means that essentially any (coil) winding can be shaped differently or individually so that the available winding space is filled optimally, which means essentially without gaps or free spaces. For example, the coil wire for winding the teeth is formed to an essentially rectangular wire cross-section, and is routed between the teeth as a non-formed round wire.

An additional or another aspect of the invention makes provision that, in order to provide a toothed motor part of an electric motor with a winding using a coil wire with a round wire cross-section, the coil wire is converted in a forming process into a coil wire with a rectangular wire cross-section, and the formed coil wire is wound around the teeth of the motor part to produce a rotating field winding. The shape of the rectangular wire cross-section of the formed coil wire is varied during the course of producing the rotating field winding. To this end, provision is made that one or more angles of inclination between the lateral faces of the rectangular wire cross-section of the formed coil wire is or are varied during the course of producing the rotating field winding.

In an embodiment, the formed coil wire is wound on a bobbin surrounding the applicable tooth. The bobbin, preferably made of an insulating material, is a one-piece or multi-piece tube section that is approximately rectangular, for example. The bobbin preferably has flange collars at the ends, which is to say perpendicular to the longitudinal direction of the tooth, between which the available winding space is delimited. The bobbin thus prevents the rotating field winding from sliding down from the teeth of the motor part. It is conceivable here, for example, that the bobbins are first wound as individual segments, and are subsequently placed on the teeth.

The coil wire can be rolled during the forming process. In this way, a technically uncomplicated and especially economical forming of the coil wire is achieved. It is possible in this case that the round wire cross-section of the coil wire is formed into an arbitrary, variable wire cross-section through one or more successive rolling processes.

The apparatus according to the invention for carrying out the method has a winding device for providing the motor part with a winding or for winding the coil wire around the teeth to produce the rotating field winding. To this end, the apparatus usefully has a spool as a coil wire supply for supplying the coil wire to the winding device. The coil wire of the spool has a round wire cross-section here. In (winding) operation, coil wire is automatically carried along a feed direction from the spool to the winding device. A forming device is arranged along the feed path thus created. In other words, the forming device is arranged between the spool and the winding device. During the course of a forming process, the coil wire is formed by the forming device from a round wire cross-section into a rectangular cross-section, or into a wire cross-section that differs from the round wire cross-section. The formed coil wire is fed to the winding device with the result that a rotating field winding that is especially efficient in terms of fill factor is wound on the teeth. The forming device is coupled to a controller (which is to say a control unit).

The controller here is equipped in general—in terms of programming and/or circuitry—to carry out the above-described method according to the invention. The controller is thus equipped in concrete terms to control the forming process carried out by the forming device, which is to say to regulate the forming of the wire cross-section into an arbitrary, for example quadrilateral, in particular rectangular, cross-sectional shape. In one possible embodiment, the controller is also designed to control the winding device so that one common controller is used for the forming process and the winding process.

In an embodiment, the controller is composed, at least at its core, of a microcontroller with a processor and a data memory, in which the functionality for carrying out the method according to the invention is implemented by programming in the form of operating software (firmware) so that the method is carried out automatically —if applicable, in interaction with a user of the apparatus—when the operating software is executed in the microcontroller. Alternatively, however, within the scope of the invention, the controller can also be composed of a non-programmable electronic component, as for example an application-specific integrated circuit (ASIC), in which the functionality for carrying out the method according to the invention is implemented by a circuit.

In an embodiment, the forming device has a number of rollers arranged one behind the other in the feed direction of the coil wire to the winding device. As a result, the coil wire is formed into an arbitrary, for example quadrilateral or rectangular, cross-sectional wire shape in multiple, successive rolling processes. For this purpose, in a preferred embodiment the rollers are, in particular, adjusted or adjustable in a pivot angle relative to one another. In other words, the controller can adjust the rollers horizontally, vertically, and also in the pivot angle relative to one another. By means of the pivot angle, it is possible, for example, to change the angle of inclination between the lateral faces of a rectangular wire cross-section so that the coil wire can be formed without difficulty into a parallelogram-shaped or trapezoid-shaped wire cross-section.

In an embodiment, the winding tool is implemented as a coil winding tool or single segment winding tool for carrying out a coil winding method or single segment winding method. In this way, a structurally simple and economical winding tool is provided.

In an embodiment, the rollers of the forming device are driven, wherein the coil wire is pressed through the rollers for forming. In this way, the forming device or the apparatus can be implemented without a wire braking system. Moreover, the (tensile) loading on the coil wire during forming is reduced.

In the preferred application, the method is used for winding a stator for an electric motor. The stator preferably is implemented in a star/yoke arrangement, wherein the individual teeth, in particular segment-like teeth, face outward in the unassembled state. The teeth are surrounded by bobbins, for example, and are each wound individually with a coil by means of the coil or single segment winder. Next, the teeth are joined to form a star core, and then a yoke core is pressed over the star core to form the stator core. Lastly, the coils are connected, for example by means of an installation ring, to form a rotating field winding comprising multiple (motor) phases, wherein the rotating field winding includes at least one coil per phase.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is in schematic representation, an apparatus for winding a stator with a coil wire, having a spool and having a forming device and also having a winding tool;

FIG. 2 is in a top view, a cross-sectional representation of a wound stator tooth with a bobbin with a single-layer coil winding;

FIG. 3 is in a top view, a cross-sectional representation of the wound stator tooth with the bobbin with a multilayer coil winding;

FIG. 4 is in a perspective representation, the coil wire with a round wire cross-section;

FIG. 5 is in a perspective representation, a formed coil wire with a rectangular wire cross-section;

FIG. 6 is in a perspective representation, a formed coil wire with a trapezoidal wire cross-section;

FIG. 7 is in a top view, a cross-sectional representation of a wound bobbin with a single-layer coil winding with an oval wire cross-section; and

FIG. 8 is in a top view, a cross-sectional representation of a wound bobbin with a multilayer coil winding with an oval wire cross-section.

### DETAILED DESCRIPTION

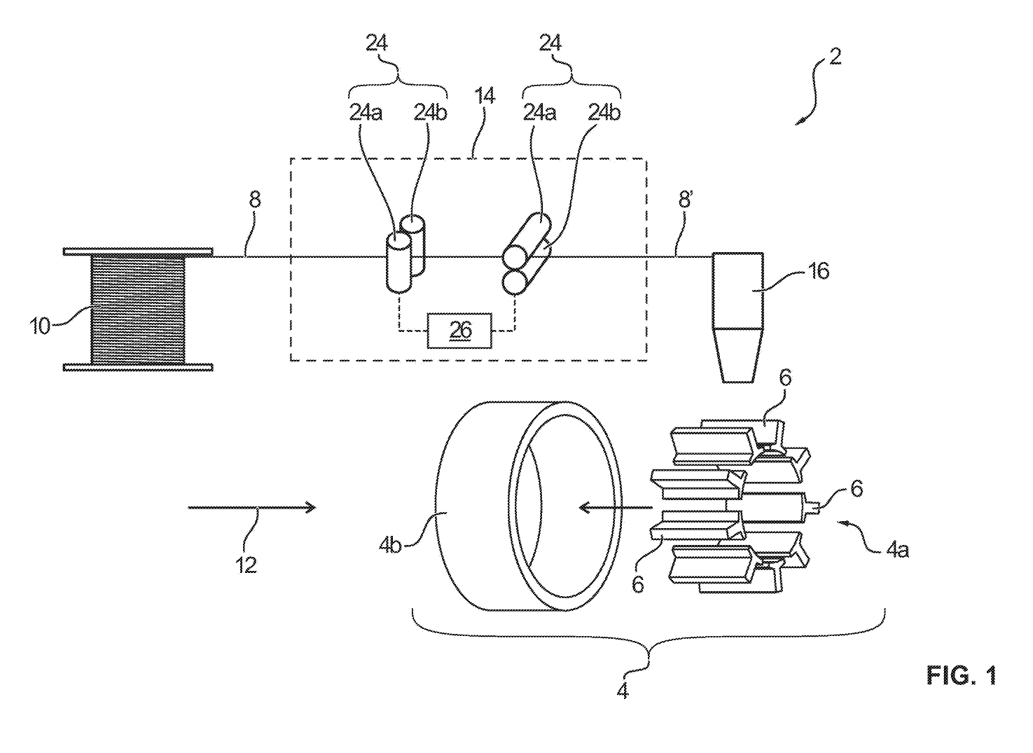

In FIG. 1, an apparatus 2 for providing a toothed motor part 4, in particular a stator 4, with a winding is shown in a schematic and highly simplified representation. The apparatus 2 is suitable and equipped to wind the (stator) teeth 6 of the stator 4 with a coil wire 8 to produce a rotating field winding.

The apparatus 2 includes a spool 10, on which coil wire 8 is supported in a coiled manner. At one free end, the coil wire 8 is carried along a feed direction 12 to a forming device 14. Downstream of the forming device 14, following essentially without interruption, is a winding device 16, with which the formed coil wire 8′ is wound on the teeth 6 of the stator 4.

The stator 4 is composed substantially of a stator core 4a and a yoke core 4b, which in the assembled state essentially forms an annulus-like laminated core with a number of inwardly directed teeth 6 arranged in a star shape.

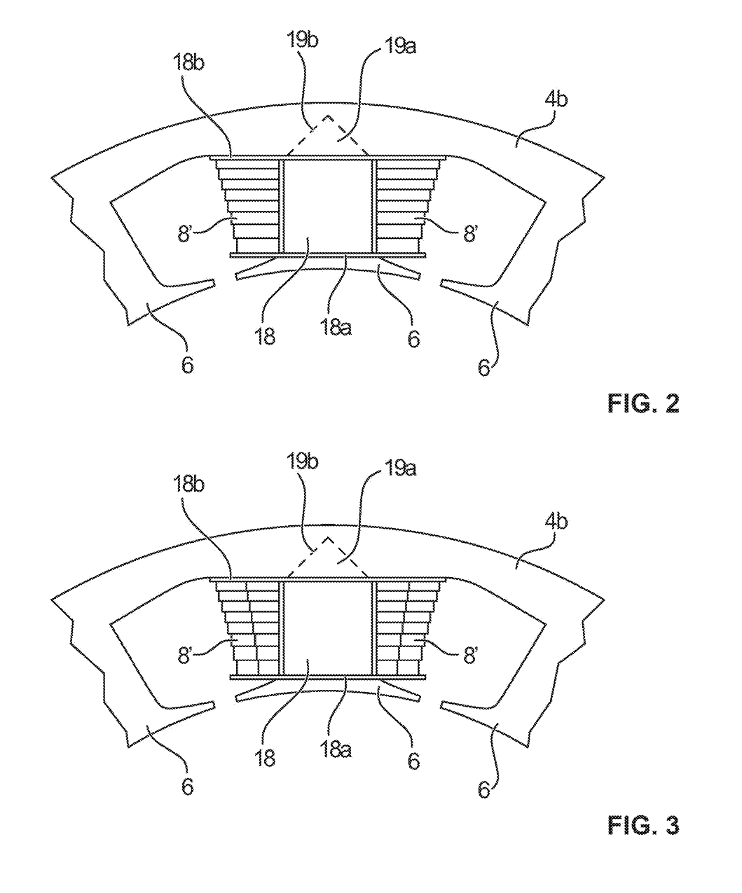

As can be seen in FIGS. 2 and 3, a tubular bobbin 18, which encloses the associated tooth 6, is arranged preferably on each of the teeth 6 of the stator 4. The bobbins 18 are preferably made of an electrically insulating material as an injection-molded part. In the assembled state, the bobbins 18 are arranged around the teeth 6, and they each have—with reference to the central recess of the stator 4—an interior flange collar 18a and an exterior flange collar 18b as the delimitation of the applicable winding space.

The star core 4a is essentially composed of a number of separate teeth or toothed segments 6. The bobbins 18 are placed on the toothed segments 6 and are individually wound with the coil wire 8′ by the winding device 16, which is implemented as a single segment winder, in particular. Alternatively, the bobbins 18 are first wound, and are then placed on the toothed segments 6. After the winding of the coil thus created, the coil wire 8′ is cut to length. After the assembly of the stator 4, the coil ends thus created of the individual coils are connected, for example by means of an installation ring, to form a common rotating field winding.

As can be seen especially well in FIG. 2 and FIG. 3, the toothed segments 6 have, on the yoke side, an approximately roof-shaped joint contour 19a, which is inserted in a corresponding joint seat 19b of the yoke core 4b upon insertion in the yoke core 4b. The joint contour 19a and joint seat 19b are only indicated with dashed lines in FIG. 2 and FIG. 3 here.

To prevent a tangential tilting of the applicable tooth 6, the inside perimeter of the yoke core 4b has a polygonal cross-section, in particular. In useful fashion, the inside perimeter of the yoke core 4b in this case has a number of inner edges formed thereby corresponding to the number of teeth 6, wherein each straight inner edge has a joint seat 19b in the center. As becomes relatively clear in FIGS. 2 and 3, the flange collar 18b of the bobbin 18 on the outer perimeter side rests over essentially its entire width on such an inner edge of the yoke core 4b so that the tooth 6 is secured against tilting.

The joining of the stator 4, formed of the star core 4a composed of individual toothed segments 6 and the yoke core 4b, by means of the joint contours 19a and joint seats 19b, and in particular the securing against tilting by means of the bobbin 18, are considered an independent invention.

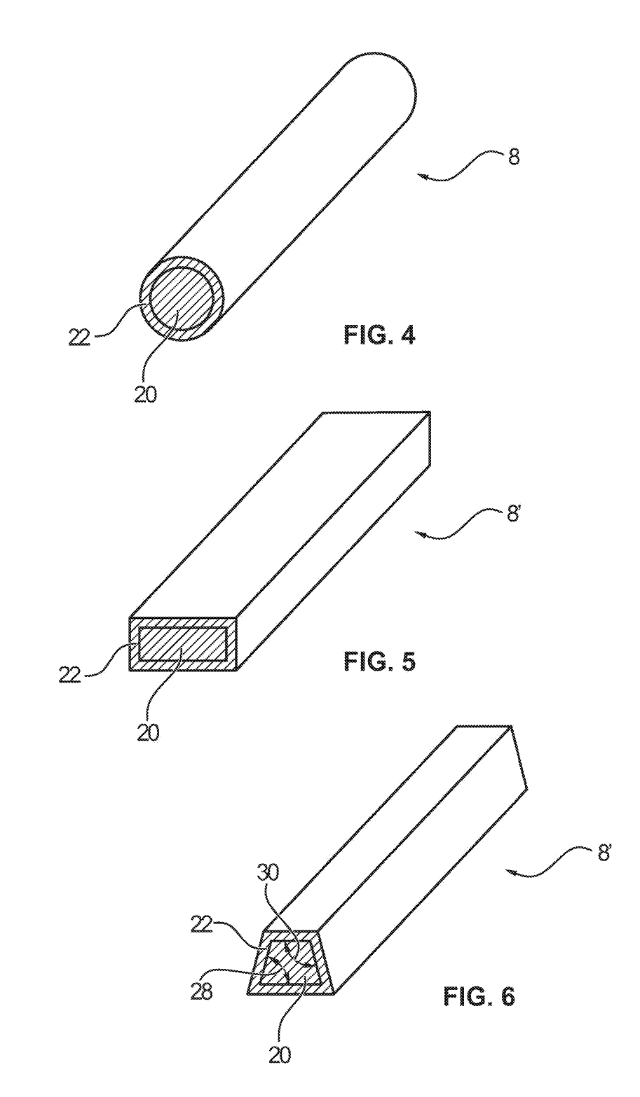

The coil wire 8 is implemented as an insulated wire with an electrically conductive conductor 20, and with insulation 22 jacketing the same. The conductor 20 is preferably made of an easily deformable copper material that is coated with an electrically insulating varnish as insulation 22. The coil wire 8 is, in particular, a round wire, which means that the coil wire 8 has—as is shown in FIG. 4—a substantially circular wire cross-section.

In operation of the apparatus 2, the coil wire 8 is reeled off of the spool 10 and conveyed in the feed direction 12 to the forming device 14. The forming device 14 has two pairs of rollers 24 oriented substantially perpendicular to one another, with which the coil wire 8 is formed from a round wire cross-section into a wire cross-section that differs from round, in particular in this exemplary embodiment, into a substantially rectangular wire cross-section. The rollers 24a, 24b, which are arranged in pairs, are staggered and arranged one behind the other with respect to the feed direction 12 so that the coil wire 8 is formed incrementally, in particular. The roller pairs 24 are connected to a common controller 26 as the control unit.

The coil wire 8 is usefully passed through, in particular pressed through, between the rollers 24a, 24b of the applicable roller pair 24, so that the coil wire 8 is rolled between the rollers 24a, 24b. The coil wire 8 can be converted into a rectangular wire cross-section—as is shown by way of example in FIG. 5—by the roller pairs 24. The coil wire 8′, which consequently is formed somewhat in the manner of a flat wire, is then fed to the winding device 16. The winding device 16 winds the coil wire 8′ on the teeth 6 or the bobbins 18 in order to produce the rotating field winding.

The controller 26 is suitable and equipped to drive the roller pairs 24 during the course of producing the rotating field winding in such a manner that the shape of the wire cross-section of the formed coil wire 8′ is varied. This means that the controller 26 causes an appropriate control signal that moves the rollers 24a, 24b of the applicable roller pair 24 toward one another or away from one another, by which means the height-to-width ratio of the, e.g., rectangular wire cross-section is changed. In other words, over the course of the rotating field winding, the coil wire 8′ has a wire cross-section with a number of different shapes that transition integrally into one another and in which the wire cross-sectional area that is enclosed in each case remains substantially the same. This is indicated by way of example in FIG. 2 and FIG. 3, wherein the coil wire 8′ is formed to be increasingly flatter toward the outer circumference of the stator 4. In this way, an especially high fill factor is realized in the winding space between the flange collars 18a and 18b.

In an additional or alternative embodiment, the roller pairs 24, or the individual rollers 24a, 24b of the roller pairs 24, are designed to be pivotable toward or with respect to one another. In this way, it is possible to vary one or more angles of inclination 28, 30 between the lateral faces of the formed coil wire 8′ during the forming. In this way, the coil wire 8 can be formed into a coil wire 8′ with a trapezoidal wire cross-section shown in FIG. 6, for example.

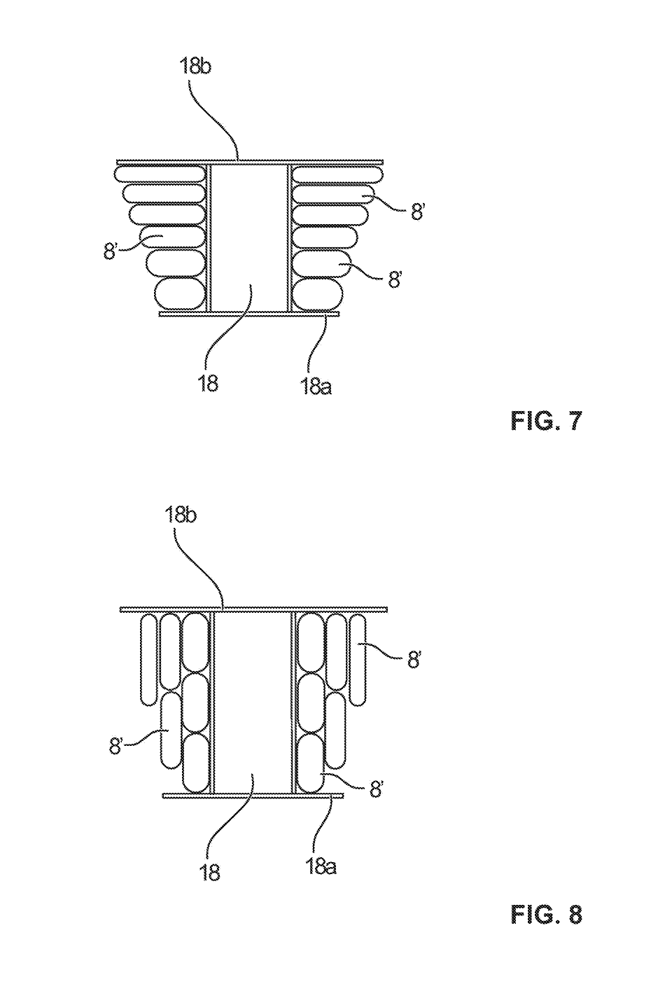

Shown as details in FIG. 7 and in FIG. 8 are two additional bobbins 18, on each of which is wound a coil wire 8′. FIGS. 7 and 8 each show a variable cross-sectional shape of the coil wire 8′ during the course of the coil winding or rotating field winding.

The upright or radially varying coil winding in FIG. 7 is essentially identical to the winding from FIG. 2, although the coil wire 8′ in FIG. 7 is not quadrangular rolled into a rectangular wire cross-section. The coil wire 8 in the exemplary embodiments from FIG. 7 and FIG. 8 is merely rolled flat on two sides from the round wire cross-section so that the narrow sides or lateral edges are approximately semicircular in design. In other words, the coil wire 8 is rolled on two diametrically opposed faces or longitudinal sides for forming.

The exemplary embodiment from FIG. 8 here shows a coil winding of the bobbin 18 in which the coil wire 8′ is wound flat. In other words, the wire cross-section essentially is not varied for sequential (coil) windings, but rather for sequential coil layers or coil courses. This means that, proceeding from the bobbin carrier 18 [sic; presumably should say “bobbin 18”], the wire cross-section is varied in the transverse direction, which is to say in the tangential or circumferential direction in the assembled state.

The invention is not limited to the exemplary embodiments described above. Instead, other variants of the invention can also be derived therefrom by the person skilled in the art without departing from the subject matter of the invention. In particular, moreover, all individual features described in connection with the exemplary embodiments may also be combined with one another in other ways without departing from the subject matter of the invention.

Thus it is also possible, for example, to form the coil wire 8 into a polygonal, in particular triangular or hexagonal, wire cross-section. The essential point is that the cross-sectional geometry is designed to be variable within one coil or rotating field winding. In particular, the winding start and the winding end, which means the coil or phase ends, are implemented as non-formed round wire 8, wherein the windings or turns are wound with the formed flat or shaped wire 8′, in particular. In particular, it is possible here that each turn of a coil has an individual and different wire cross-section from the adjacent turns.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for providing a toothed motor part of an electric motor with a winding using a coil wire with a round wire cross-section, the method comprising:
converting the coil wire into a coil wire with a wire cross-section different from the round wire cross-section in a forming process; and
wounding the formed coil wire around teeth of the motor part to produce a rotating field winding.

2. The method according to claim 1, wherein a cross-sectional shape of the formed coil wire is varied during a course of producing the rotating field winding.

3. The method according to claim 1, wherein one or more angles of inclination between the lateral faces of the wire cross-section of the formed coil wire is or are varied during the course of producing the rotating field winding.

4. A method for providing a toothed motor part of an electric motor with a winding using a coil wire with a round wire cross-section, the method comprising:
converting the coil wire into a coil wire with a rectangular wire cross-section in a forming process;
wounding the formed coil wire around teeth of the motor part to produce a rotating field winding;
varying a shape of the rectangular wire cross-section of the formed coil wire during a course of producing the rotating field winding; and
varying one or more angles of inclination between the lateral faces of the rectangular wire cross-section of the formed coil wire during the course of producing the rotating field winding.

5. The method according to claim 1, wherein the formed coil wire is wound on a bobbin surrounding the applicable tooth.

6. The method according to claim 1, wherein the coil wire is rolled during the forming process.

7. An apparatus for carrying out the method according to claim 1, the apparatus comprising:
a winding device for providing the motor part with a winding;
a spool for supplying the winding device with the coil wire;
a forming device arranged between the spool and the winding device for converting the cross-sectional shape of the coil wire from a round wire cross-section into a rectangular cross-section or into a wire cross-section that differs from the round wire cross-section; and
a controller for controlling the forming device.

8. The apparatus according to claim 7, wherein the forming device has a number of rollers arranged one behind the other in the feed direction of the coil wire to the winding device.

9. The apparatus according to claim 8, wherein the rollers are adjusted or adjustable in a pivot angle relative to one another.

10. The apparatus according to claim 7, wherein the winding device is a coil winding tool or single segment winding tool.

11. The apparatus according to claim 7, wherein the forming device drives the rollers and presses the coil wire through the rollers.

12. A stator for an electric motor, provided with a winding in accordance with the method according to claim 1.
